(19) United States
(12) Patent Application Publication
(10) Pub. No.: US 2018/0345719 A1
(43) Pub. Date: Dec. 6, 2018

(54) A DEVICE FOR ATTACHMENT TO A SPOKED BICYCLE WHEEL

(71) Applicants: Andrew James Maxwell, County Waterford (IE); Thomas Donald Maxwell, County Waterford (IE)

(72) Inventors: Andrew James Maxwell, County Waterford (IE); Thomas Donald Maxwell, County Waterford (IE)

(21) Appl. No.: 15/757,760

(22) PCT Filed: Aug. 30, 2016
(86) PCT No.: PCT/EP2016/070385

§ 371 Date: Mar. 6, 2018

(30) Foreign Application Priority Data
Sep. 7, 2015 (GB) 1515818.1

(51) Int. Cl. B60B 7/04; B60B 7/18; B60B 7/06; B60B 7/00; B60B 7/10

(52) U.S. Cl. CPC B60B 7/04; B60B 7/18; B60B 1/003; B60B 7/0006; B60B 7/10; B60B 7/066

(57) ABSTRACT

A device (10) for attachment to a spoked bicycle wheel (not shown, comprises a central section (11) locatable around the wheel hub (not shown), and a plurality of elongate members (12, 13, 14, 15, 21) attachable to the central section (11). When attached to the central section (11), the elongate members (12, 13, 14, 15, 21) are radially and equidistantly disposed thereabout. The length of the and each elongate member (12, 13, 14, 15, 21) is adjustable, if required, such that, in use, the elongate members (12, 13, 14, 15, 21) extend from the central section (11) to the rim of the wheel (not shown).

### TECHNICAL FIELD

This invention relates to a device for attachment to a spoked bicycle wheel and, in particular, to a device which is locatable around the wheel hub.

### BACKGROUND ART

Devices are known which are attached to the wheel of a bicycle, to provide a customised appearance to the bicycle. A number of devices for customising a spoked bicycle wheel are known.

U.S. Pat. No. 3,602,550 discloses a cover for a spoked wheel which includes a pair of side cover plates. Each of the cover plates includes a planar annular band and a plurality of radially tapering projections which are integral with the band and extend inwardly thereof. The band has an outer diameter which is substantially equal to the inner diameter of the rim of the wheel. The plates are secured on opposite sides of the wheel and the projections thereof are adapted to conform to the pitch of the spokes of the wheel.

However, as the cover plates of U.S. Pat. No. 3,602,550 are designed to fit a particular wheel diameter, it is necessary to provide a range of cover plates to fit various wheel diameters.

Also, fitment of the device to the bicycle requires the removal of the wheel from the bicycle, which takes time and may compromise the integrity of the bicycle, if the wheel is replaced incorrectly.

US Patent Publication US 2006/0087171 discloses spinning rims for a bicycle, including a spinning rim assembly having a wheel and a wheel hub, and a bearing assembly configured to provide independent rotational motion between a connecting member and the wheel hub. The spinning rim is centrally disposed within the wheel, and rotates via the bearing assembly and independently of the wheel when the bicycle is in motion.

However, in use, the rims move of their own inertia, and not that of the bicycle wheel. The spinning rim acts as a bicycle accessory, and is not considered part of a customised bicycle. Also, as the device forms an integral part of the wheel, retrofitting it to a bicycle would require the replacement of the current bicycle wheel.

It is an object of the present invention to overcome the disadvantages of the devices hereinbefore described.

### DISCLOSURE OF INVENTION

Thus, the invention provides a device for attachment to a spoked bicycle wheel, the device comprising a central section locatable around the wheel hub, a plurality of elongate members, cooperating formations for attaching the elongate members to the central section, the cooperating formations being on one end of the and each elongate member and on the central section, with the and each elongate member, when attached to the central section, being radially and equidistantly disposed thereabout, and with the length of the and each elongate member being adjustable, if required, such that, in use, the elongate members extend from the central section to the rim of the wheel.

The term “bicycle” as used herein is intended to encompass bicycles, tricycles, scooters and other vehicles with spoked wheels.

An advantage of the device according to the invention is that the one device is suitable for attachment to a variety of wheel diameters.

The elongate members can be designed to produce different effects when the device is attached to the wheel e.g. they can simulate the spokes of an alloy wheel.

In one embodiment of the device according to the invention, the central section is a flat, resilient ring, and the cooperating formations are a plurality of slots disposed around the periphery of the resilient ring, and a formation near the one end of the and each elongate member, which formations cooperate with the slots to hold the and each elongate member in place once it has been passed through a respective slot, in use.

An advantage of this aspect of the device is that the elongate members can be attached to the central section after the central section has been located around the wheel hub.

Preferably, a stop is located on the central section, between the and each slot and the centre of the central section, which stop prevents the elongate member from passing further through the slot, in use.

An advantage of this aspect of the device is that, in use, the members remain in a fixed position.

In a further embodiment of the device according to the invention, the formation near the one end of the and each elongate member is an indent located on each side thereof, which indents cooperate with the respective slot in the central section.

An advantage of this aspect of the device is that, in use, the elongate member can be attached to the central unit with relative ease.

In a further embodiment of the device according to the invention, the formation near the one end of the and each elongate member is a resilient, centrally located flap located on the longitudinal axis thereof, which flap cooperates with the respective slot of the central section.

An advantage of this aspect of the device is that, the attachment point of the elongate member to the central unit is easily found.

Preferably, the formation near the one end of the and each elongate member is repeated at intervals therealong, with the length of the and each elongate member being adjustable by trimming adjacent to a particular formation, such that the trimmed length is appropriate for a particular wheel size.

An advantage of this aspect of the device is that the elongate member can be trimmed to allow for attachment of the device to different sizes of bicycle wheel.

In a further embodiment of the device according to the invention, the resilient ring has a break therein, such that, in use, the resilient ring is locatable around the wheel hub by passage of the hub through the break.

An advantage of this aspect of the device is that the resilient ring may be located around the hub with relative ease, without distorting the ring.

A further advantage of this aspect of the device is that the device can be attached to the bicycle wheel without having to remove the wheel from the bicycle.

Preferably, the break in the ring is closed by means of a resilient fastener, following attachment of the resilient ring around the hub.

An advantage of this aspect of the device is that the break in the ring can be held shut, reducing the risk of the ring coming free from the bicycle hub.

Alternatively, the break in the ring is closed by means of a hook and clip fastener, following attachment of the resilient ring around the hub.

An advantage of this aspect of the device is that the ring can be made from one piece of material, without any loose parts.

In a further embodiment of the device according to the invention the central section is a pair of annular frames having mating formations thereon for joining them together, in use, with the elongate members being held between the pair of annular frames.

An advantage of this aspect of the device is that the pair of annular frames adds strength to the assembled device.

A further advantage of this aspect of the device is that the device can be assembled in tight spaces such as within the space between the spokes of a small diameter wheel.

Preferably, the pair of annular frames is a male and a female frame and the mating formations are a set of resilient pins arranged on a surface of the male annular frame and a complementary set of mating orifices arranged on a surface of the female annular frame, with the male and female annular frames being joined together, in use, by locating the and each pin in a corresponding mating orifice.

An advantage of this aspect of the device is that once the pair of annular frames has been aligned it is easy to join the frames together.

Further, preferably, the cooperating formations for attaching the elongate members to the central section are a pair of openings located near one end of the and each elongate member, and a pair of the resilient pins on the male annular frame, which are passable through the pair of openings on a corresponding elongate member, in use, such that the and each elongate member is held in the correct position.

An advantage of this aspect of the device is that, in use, the and each elongate member can be attached to the male annular frame and the male and female annular frames can then be joined together. This arrangement contributes to the ease of assembly of the device.

In a further embodiment of the device according to the invention, the pair of openings near the one end of the and each elongate member is repeated at intervals therealong, with the length of the and each elongate member being adjustable by trimming adjacent to a particular pair of openings, such that the trimmed length is appropriate for a particular wheel size.

An advantage of this aspect of the device is that the elongate member can be trimmed to allow for attachment of the device to different sizes of bicycle wheel.

In a further embodiment of the device according to the invention, each annular frame has a break therein, such that, in use, each annular frame is locatable around the wheel hub by passage of the hub through the break.

An advantage of this aspect of the device is that the device can be attached to the bicycle wheel without having to remove the wheel from the bicycle.

In a further embodiment of the device according to the invention, means for attachment of the and each elongate member to a bicycle spoke is associated therewith.

An advantage of this aspect of the device is that the device can be secured to the spokes to provide extra security.

Preferably, the attachment means is a resilient clip.

An advantage of this aspect of the device is that the device can be installed and removed quickly and simply from the bicycle.

Alternatively, the attachment means is a cable tie.

An advantage of this aspect of the device is that the device can be manufactured cheaply, and its components can be easily replaced.

In a further embodiment of the device according to the invention, the and each elongate member is laterally extended at the other end thereof, with a plurality of orifices disposed near the periphery of the laterally extended end, at least one of which orifices is locatable adjacent to a bicycle spoke, in use.

An advantage of this aspect of the device is that the elongate members abut the inner surface of the bicycle rim such that, in use, when each elongate member has been attached to the central unit, the device has the appearance of a spoked alloy wheel with the spokes being seamlessly attached to the rim.

Preferably, the device is locatable, in use, within the wheel space internally of the spokes.

An advantage of this aspect of the device is that, in use, the device is less prone to damage or wear and tear as the device is protected by the spokes of the bicycle wheel.

### BRIEF DESCRIPTION OF DRAWINGS

The invention will be further illustrated by the following description of embodiments thereof, given by way of example only with reference to the accompanying drawings in which:

FIG. 1 is a schematic representation of a device in accordance with the invention in a partially assembled state;

FIG. 2 is a schematic representation of the device of FIG. 1 in a fully assembled state;

FIG. 3 is a schematic representation of a further embodiment of a device in accordance with the invention in a partially assembled state;

FIG. 4 is a schematic representation of the device of FIG. 3 in a fully assembled state;

FIG. 5 is a schematic representation of a still further embodiment of a device in accordance with the invention in use, located externally of the bicycle wheel spokes;

FIG. 6 is a schematic representation of a still further embodiment of a device in accordance with the invention in use, located externally of the bicycle wheel spokes;

FIG. 7 is a schematic representation of a still further embodiment of a device in accordance with the invention in use, located within the wheel space internally of the bicycle wheel spokes;

FIG. 8 is a schematic representation in an exploded view of a still further embodiment of a device in accordance with the invention;

FIG. 9 is a schematic representation in an exploded view of the central section of the device of FIG. 8;

FIG. 10 is a schematic representation of the device of FIG. 8 in a fully assembled state; and

FIG. 11 is a schematic representation of a still further embodiment of a central section of a device in accordance with the invention.

### MODES FOR CARRYING OUT THE INVENTION

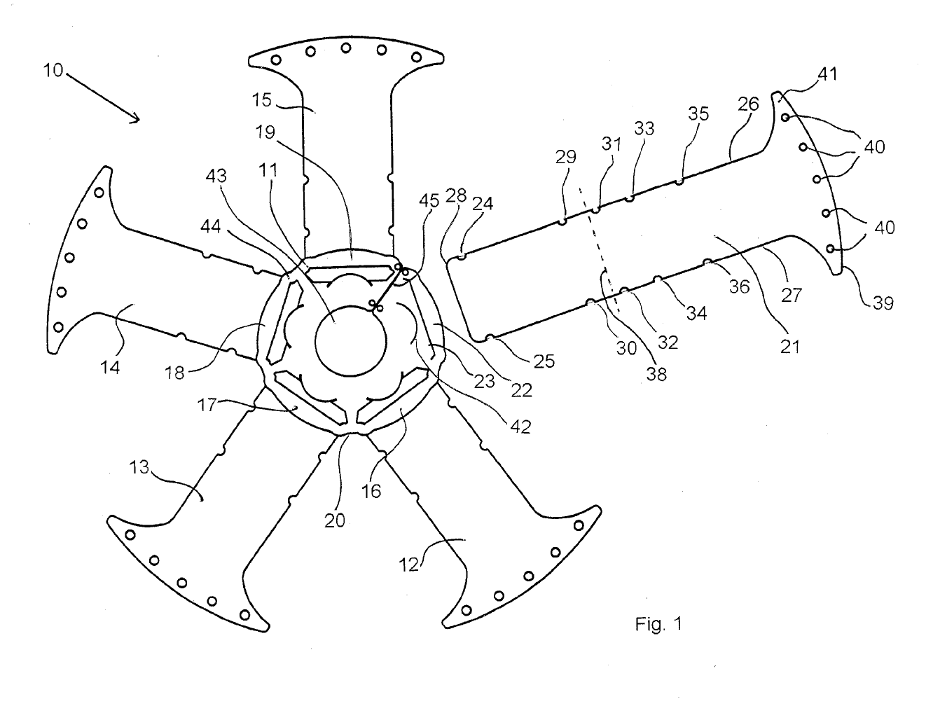

Referring to FIG. 1, there is illustrated generally at 10, a device for attachment to a spoked bicycle wheel (not shown). The device 10 comprises a central section 11 locatable around the wheel hub (not shown), and four elongate members 12, 13, 14, 15 attached at positions 16, 17, 18, 19, respectively along the periphery 20 of the central section 11. A fifth elongate member 21 is attachable to the central section 11 at position 22 on the periphery 20, via a cooperating formation in the form of a slot 23 on the central section 11, and cooperating formations in the form of a pair of indents 24, 25 on sides 26, 27, respectively and to one end 28 of the elongate member 21. Further pairs of indents 29, 30; 31, 32; 33, 34; and 35, 36 are located along sides 26, 27, respectively. The length of the elongate member 21 is adjustable by trimming adjacent to a particular pair of indents 29, 30; 31, 32; 33, 34; and 35, 36 (illustrated by dotted line 38 adjacent to the pair of indents 31, 32) such that, in use, the trimmed length (not shown) is appropriate for a particular wheel size (not shown).

The elongate member 21 is laterally extended at other end 39 thereof, with a plurality of orifices 40 disposed near periphery 41 of the laterally extended end 39, at least one of which orifices 40 is locatable adjacent to a spoke of a bicycle wheel (not shown), in use. The end 39 of the elongate member 21 is attachable to the bicycle spoke (not shown) by means of a resilient clip (not shown), which clip is passable through an orifice 40.

A stop 42 is located on the central section 11, between the slot 23 and centre 43 of the central section 11, which stop 42 prevents the elongate member 21 from passing further through the slot 23, in use.

Elongate members 12, 13, 14, 15 are attached to the central section 11 in the same manner as has been hereinbefore described for elongate member 21.

The central section 11 is a flat, resilient ring 44, which resilient ring 44 has a break 45 therein, such that, in use, the resilient ring 44 is locatable around the wheel hub (not shown) by passage of the hub through the break 45.

The break 45 in the ring 44 is closed by means of a resilient fastener (not shown) following attachment of the resilient ring 44 around the hub (not shown).

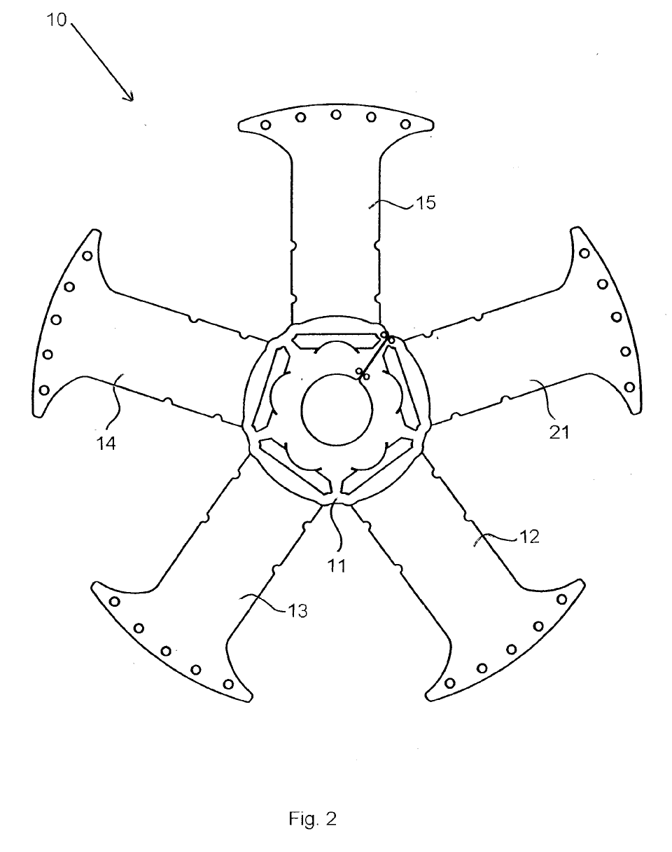

Referring to FIG. 2, the device 10 of FIG. 1 is shown in a fully assembled state.

In use, when attached to the central section 11, the elongate members 12, 13, 14, 15, and 21, which has been trimmed at dotted line 38 (see FIG. 1) prior to attachment, are radially and equidistantly disposed thereabout, such that, in use, the elongate members 12, 13, 14, 15, 21 extend from the central section 11 to the rim of the bicycle wheel (not shown).

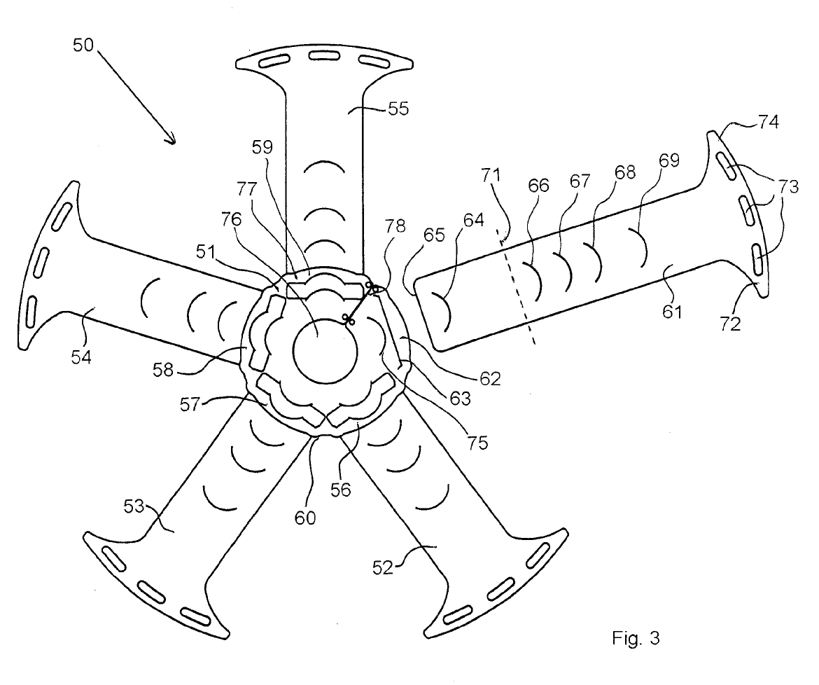

Referring to FIG. 3, there is illustrated generally at 50, a further embodiment of a device in accordance with the invention in a partially assembled state.

The device 50 comprises a central section 51 locatable around the wheel hub (not shown), and four elongate members 52, 53, 54, 55 attached at positions 56, 57, 58, 59, respectively along the periphery 60 of the central section 51. A fifth elongate member 61 is attachable to the central section 51 at position 62 on the periphery 60, via a cooperating formation in the form of a slot 63 on the central section 51, and a cooperating formation in the form of a resilient, centrally located flap 64 located on the longitudinal axis thereof (not shown) and to one end 65 of the elongate member 61. Further flaps 66, 67, 68, 69, similar to flap 64, are located along the longitudinal axis (not shown) of the elongate member 61. The length of the elongate member 61 is adjustable by trimming adjacent to a particular flap 66, 67, 68, 69 (illustrated by dotted line 71 adjacent to the flap 66) such that, in use, the trimmed length (not shown) is appropriate for a particular wheel size (not shown).

The elongate member 61 is laterally extended at the other end 72 thereof, with a plurality of orifices in the form of slots 73 disposed near the periphery 74 of the laterally extended end 72, at least one of which slots 73 is locatable adjacent to a spoke of a bicycle wheel (not shown), in use. The end 72 of the elongate member 61 is attachable to the bicycle spoke (not shown) by means of a resilient clip (not shown), which clip is passable through a slot 73.

A stop 75 is located on the central section 51, between the slot 63 and centre 76 of the central section 51, which stop 75 prevents the elongate member 61 from passing further through the slot 63, in use.

Elongate members 52, 53, 54, 55 are attached to the central section 51 in the same manner as has been hereinbefore described for elongate member 61.

The central section 51 is a flat, resilient ring 77, which resilient ring 77 has a break 78 therein, such that, in use, the resilient ring 77 is locatable around the wheel hub (not shown) by passage of the hub through the break 78.

The break 78 in the ring 77 is closed by means of a resilient fastener (not shown) following attachment of the resilient ring 77 around the hub (not shown).

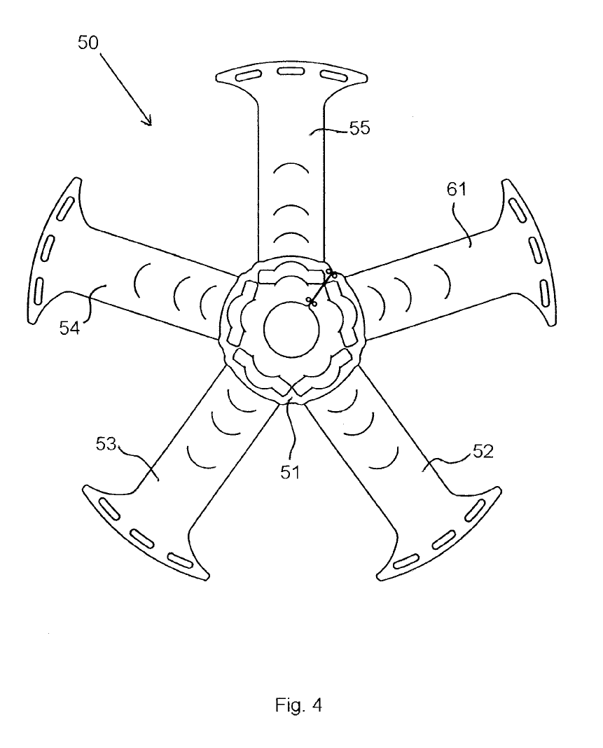

Referring to FIG. 4, the device 50 of FIG. 3 is shown in a fully assembled state.

In use, when attached to the central section 51, the elongate members 52, 53, 54, 55, and 61, which has been trimmed at dotted line 71 (see FIG. 3) prior to attachment, are radially and equidistantly disposed thereabout, such that, in use, the elongate members 52, 53, 54, 55, 61 extend from the central section 51 to the rim of the bicycle wheel (not shown).

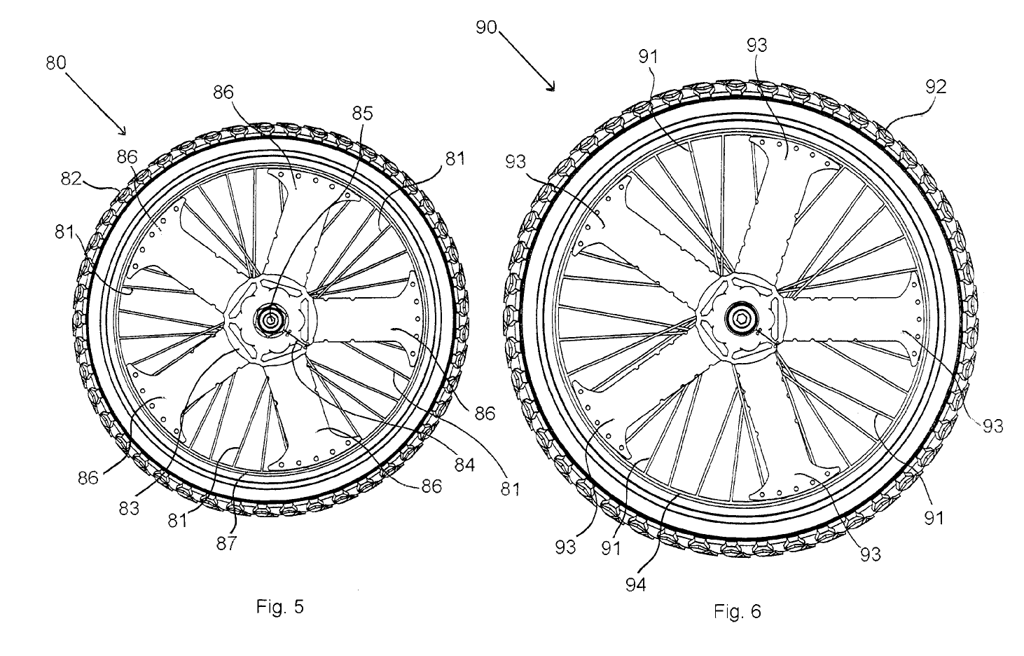

Referring to FIG. 5, there is illustrated generally at 80 a still further embodiment of a device in accordance with the invention in use, located externally of bicycle wheel spokes 81 of a bicycle wheel 82.

Central section 83 has a break 84 therein, such that, in use, the central section 83 is locatable around wheel hub 85 by passage of the hub 85 through the break 84.

Five elongate members 86 have been trimmed prior to attachment to the central section 83, such that the elongate members 86 abut rim 87 of the bicycle wheel 82.

An advantage of this aspect of the device 80 is that the device 80 can be attached to the bicycle wheel 82 without having to remove the bicycle wheel 82 from the bicycle (not shown).

Referring to FIG. 6, there is illustrated generally at 90 a still further embodiment of a device in accordance with the invention in use, located externally of bicycle wheel spokes 91 of a bicycle wheel 92.

The wheel 92 has a larger diameter than the wheel 82 (FIG. 5). Thus, elongate members 93 have been trimmed to a longer length than the corresponding elongate members 86 (FIG. 5). Again, the elongate member 93 abuts rim 94 of the bicycle wheel 92.

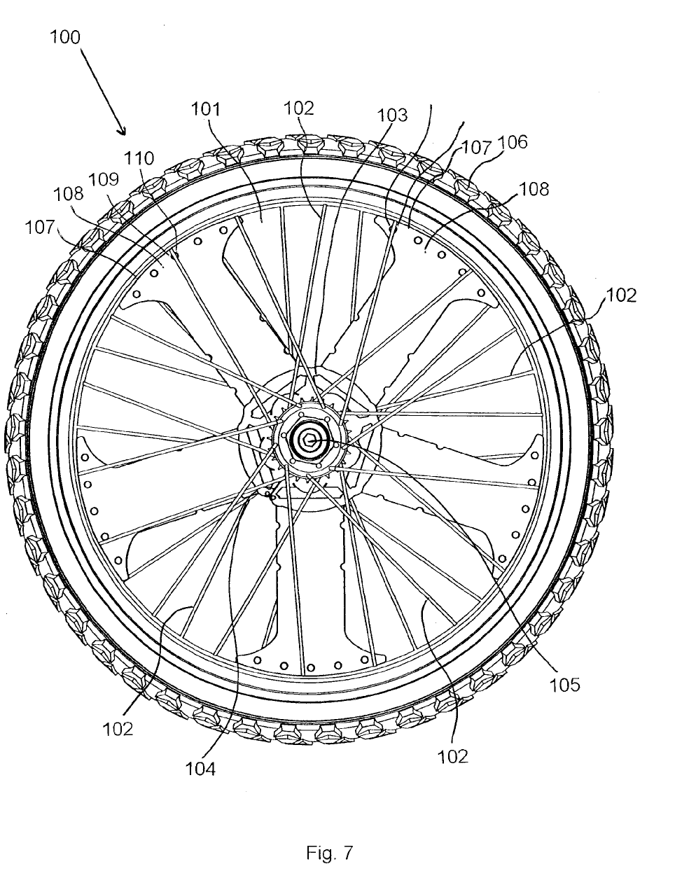

Referring to FIG. 7, there is illustrated generally at 100, a still further embodiment of a device in accordance with the invention in use, located within wheel space 101 internally of bicycle wheel spokes 102.

Central section 103 has a break 104 therein, such that, in use, the central section 103 is locatable around wheel hub 105 by passage of the hub 105 through the break 104.

An advantage of this aspect of the device 100 is that the device 100 can be attached to the bicycle wheel 106 without having to remove the wheel 106 from the bicycle (not shown).

A still further advantage of this aspect of the device 100 is that, in use, the device 100 is less prone to damage or wear and tear as the device 100 is protected by the spokes 102 of the bicycle wheel 106.

Ends 107 of two of the elongate members 108 are attached to a bicycle spoke 102 by means of a resilient clip 109, which clip 109 is passable through an orifice 110.

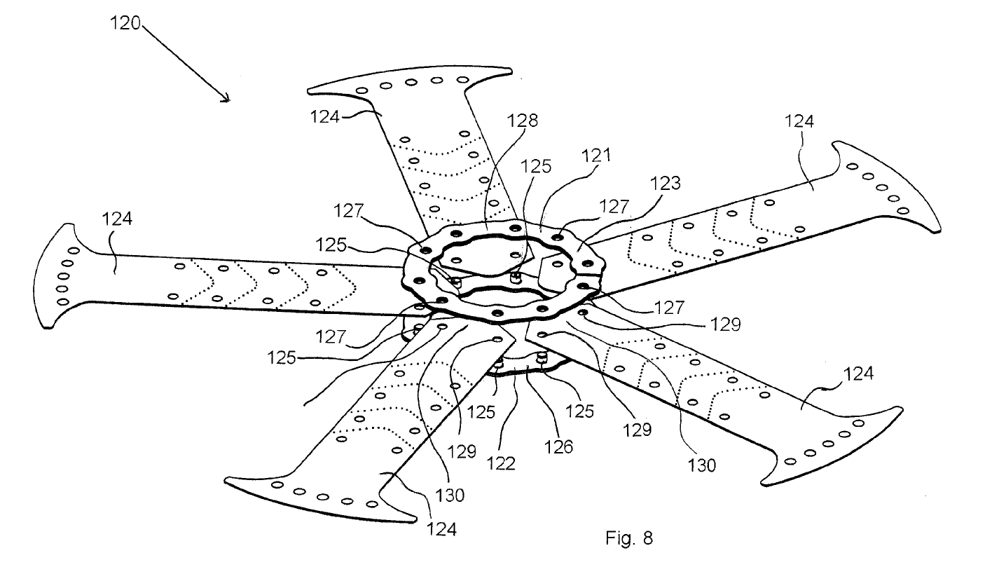

Referring to FIG. 8, there is illustrated generally at 120, a still further embodiment of a device in accordance with the invention in an exploded view.

The device 120 has a central section 121 made up from a male annular frame 122 and a female annular frame 123 and five elongate members 124 which are located between the male 122 and female annular frames 123 during assembly of the device 120.

The male annular frame 122 has a set of ten resilient pins 125 arranged on a surface 126 thereof. A complementary set of ten mating orifices 127 is arranged on a surface 128 of the female annular frame 123.

Each elongate member 124 has a pair of openings 129 located near one end 130 thereof. To assemble the device 120 the openings 129 on a particular elongate member 124 are placed over a pair of the resilient pins 125 on the male annular frame 122. The other four elongate members 124 are placed over a pair of corresponding resilient pins 125 and the male 122 and female annular frames 123 are joined together with the elongate members 124 held therebetween. Once assembled the elongate members 124 will be radially and equidistantly disposed about the central section 121.

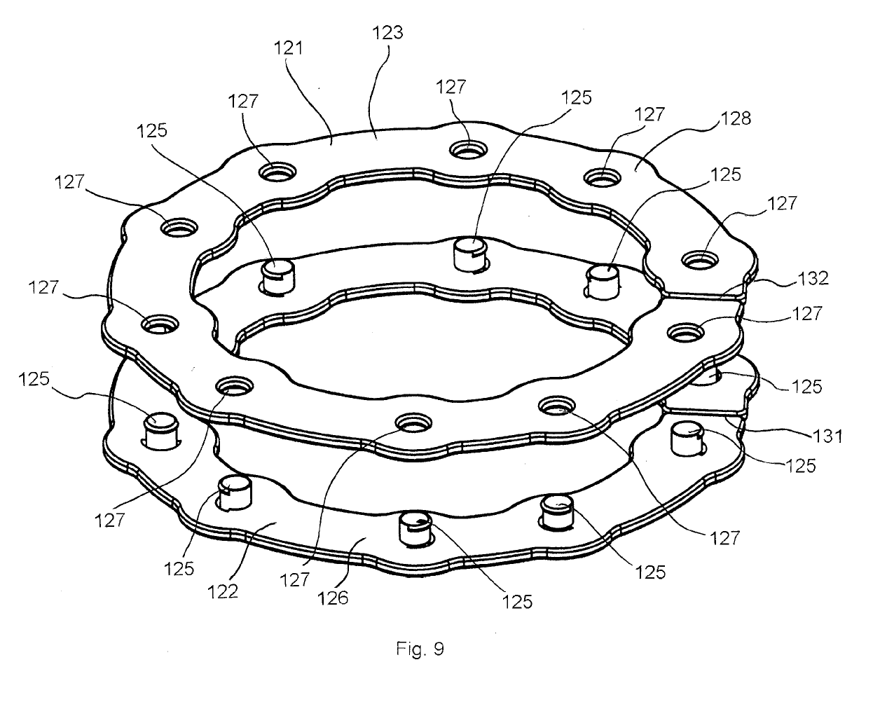

Referring to FIG. 9, the central section 121 is shown on its own in an exploded view. The male 122 and female annular frames 123 are brought together, in use, by locating the and each resilient pin 125 in a corresponding mating orifice 127 and joining them together by snap fit.

The male annular ring 122 has a break 131 therein which permits the user to locate the male annular ring 122 around the hub of a bicycle (not shown) without having to first remove the bicycle wheel from the frame. A similar break 132 in the female annular frame 123 serves the same purpose.

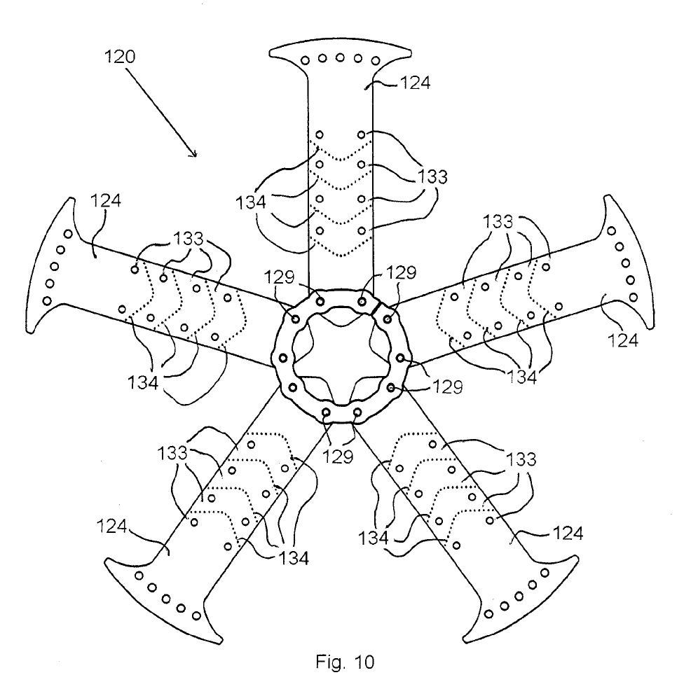

Referring to FIG. 10, the device 120 of FIG. 8 is shown in a fully assembled state. The pair of openings 129 on each elongate member 124 is repeated at intervals 133 along the length of each elongate member 124. The length of each elongate member 124 is adjustable by trimming adjacent to a particular pair of openings 129. Trimming indicator lines 134 are provided for this purpose.

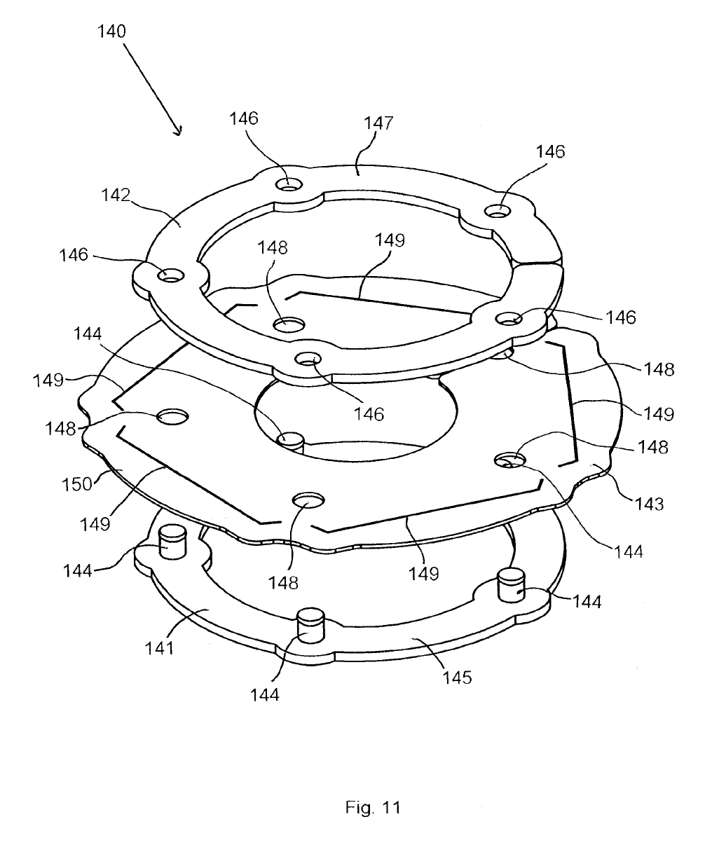

Referring to FIG. 11, there is illustrated generally at 140 a still further embodiment of a central section of a device in accordance with the invention. Central section 140 made up from a male annular frame 141 and a female annular frame 142 and a middle plate 143 sandwiched therebetween.

The male annular frame 141 has a set of five resilient pins 144 arranged on a surface 145 thereof. A complementary set of five mating orifices 146 is arranged on a surface 147 of the female annular frame 143. A matching set of five openings 148 is arranged on the middle plate 143.

Five slots 149 for receiving the elongate members (not shown) are arranged around the periphery 150 of the middle plate 143.

In use, an elongate member (not shown) is inserted into each slot 149 and the resilient pins 144, openings 148 and orifices 146 are aligned and the male annular frame 141 and the female annular frame 143 are joined together by a snap fit, with the middle plate 143 and the elongate members being sandwiched therebetween.

1.-20. (canceled)

21. A device for attachment to a spoked bicycle wheel, the device comprising a central section locatable around the wheel hub, a plurality of elongate members, cooperating formations for attaching the elongate members to the central section, the cooperating formations being on one end of the and each elongate member and on the central section, with the and each elongate member, when attached to the central section, being radially and equidistantly disposed thereabout, and with the length of the and each elongate member being adjustable, if required, such that, in use, the elongate members extend from the central section to the rim of the wheel.

22. A device according to claim 21, wherein the central section is a flat, resilient ring, and the cooperating formations are a plurality of slots disposed around the periphery of the resilient ring, and a formation near the one end of the and each elongate member, which formations cooperate with the slots to hold the and each elongate member in place once it has been passed through a respective slot, in use.

23. A device according to claim 22, wherein a stop is located on the central section, between each slot and the center of the central section, which stop prevents the elongate member from passing further through the slot, in use.

24. A device according to claim 22, wherein the formation near the one end of each elongate member is an indent located on each side thereof, which indents cooperate with the respective slot in the central section.

25. A device according to claim 22, wherein the formation near the one end of each elongate member is a resilient, centrally located flap located on the longitudinal axis thereof, which flap cooperates with the respective slot of the central section.

26. A device according to claim 22, wherein the formation near the one end of each elongate member is repeated at intervals therealong, with the length of the and each elongate member being adjustable by trimming adjacent to a particular formation, such that the trimmed length is appropriate for a particular wheel size.

27. A device according to claim 22, wherein the resilient ring has a break therein, such that, in use, the resilient ring is locatable around the wheel hub by passage of the hub through the break.

28. A device according to claim 27, wherein the break in the ring is closed by means of a resilient fastener, following attachment of the resilient ring around the hub.

29. A device according to claim 21, wherein the central section is a pair of annular frames having mating formations thereon for joining them together, in use, with the elongate members being held between the pair of annular frames.

30. A device according to claim 29, wherein the pair of annular frames is a male and a female frame and the mating formations are a set of resilient pins arranged on a surface of the male annular frame and a complementary set of mating orifices arranged on a surface of the female annular frame, with the male and female annular frames being joined together, in use, by locating the and each pin in a corresponding mating orifice.

31. A device according to claim 30, wherein the cooperating formations for attaching the elongate members to the central section are a pair of openings located near one end of the and each elongate member, and a pair of the resilient pins on the male annular frame, which are passable through the pair of openings on a corresponding elongate member, in use, such that the and each elongate member is held in the correct position.

32. A device according to claim 31, wherein the pair of openings near the one end of the and each elongate member is repeated at intervals therealong, with the length of the and each elongate member being adjustable by trimming adjacent to a particular pair of openings, such that the trimmed length is appropriate for a particular wheel size.

33. A device according to claim 31, wherein each annular frame has a break therein, such that, in use, each annular frame is locatable around the wheel hub by passage of the hub through the break.

34. A device according to claim 31, wherein each annular frame has a break therein, such that, in use, each annular frame is locatable around the wheel hub by passage of the hub through the break.

35. A device according to claim 21, including an attachment of the elongate member to a bicycle spoke is associated therewith.

36. A device according to claim 35, wherein the attachment is a resilient clip.

37. A device according to claim 35, wherein the attachment is a cable tie.

38. A device according to claim 21, wherein each elongate member is laterally extended at the other end thereof, with a plurality of orifices disposed near the periphery of the laterally extended end, at least one of which orifices is locatable adjacent to a bicycle spoke, in use.

39. A device according to claim 21, wherein the device is locatable, in use, within the wheel space internally of the spokes.
